(19) United States
(12) Patent Application Publication
(10) Pub. No.: US 2026/0104913 A1
(43) Pub. Date: Apr. 16, 2026

(54) SYSTEM AND METHOD FOR ARTIFICIAL INTELLIGENCE BASED REDUCTION OF LOG DATA

(71) Applicant: BANK OF AMERICA CORPORATION, CHARLOTTE, NC (US)

(72) Inventors: Ashwini Hosbet, Plano, TX (US); Kamal D. Sharma, Mason, OH (US)

(73) Assignee: BANK OF AMERICA CORPORATION, CHARLOTTE, NC (US)

(21) Appl. No.: 18/911,602

(22) Filed: Oct. 10, 2024

(51) Int. Cl. G06F 9/48

(52) U.S. Cl. CPC G06F 9/4831

(57) ABSTRACT

A system is provided for artificial intelligence based reduction of log data. In particular, the system may continuously monitor the log data being generated within a network environment. Using an artificial intelligence engine, the system may analyze the logs as well as the usage of the logs to determine a priority level of each component within the log data. Based on the priority levels determined through the analysis, the system may generate predicted future usage requirements of the log data based on past access patterns. prioritize the storage of log data such that storage requirements and/or retention policies may be dynamically adjusted. In this way, the system may provide an intelligent and efficient way to save precious computing resources such as storage space.

### TECHNOLOGICAL FIELD

Example embodiments of the present disclosure relate to a system for artificial intelligence based reduction of log data.

### BACKGROUND

There is a need for an intelligent and efficient way to reduce data storage requirements within a network environment.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for artificial intelligence based reduction of log data. In particular, the system may continuously monitor the log data being generated within a network environment. Using an artificial intelligence engine, the system may analyze the logs as well as the usage of the logs to determine a priority level of each component within the log data. Based on the priority levels determined through the analysis, the system may generate predicted future usage requirements of the log data based on past access patterns. prioritize the storage of log data such that storage requirements and/or retention policies may be dynamically adjusted. In this way, the system may provide an intelligent and efficient way to save precious computing resources such as storage space.

Accordingly, embodiments of the present disclosure provide a system for artificial intelligence based reduction of log data, the system comprising: a processing device; a non-transitory storage device containing instructions when executed by the processing device, cause the processing device to perform the steps of: analyzing, using an artificial intelligence engine, log data within a network environment and usage data associated with the log data; detecting, using the artificial intelligence engine, one or more usage patterns based on the log data and the usage data; identifying one or more segments of data within the log data based on detecting the one or more usage patterns; computing a priority score for each of the one or more segments of data; and executing one or more prioritization processes on each of the one or more segments of data based on the priority score for each of the one or more segments of data.

In some embodiments, executing the one or more prioritization processes comprises setting a custom retention period for each of the one or more segments of data based on the priority score for each of the one or more segments of data.

In some embodiments, setting the custom retention period comprises: detecting that a first priority score for a first segment of data of the one or more segments of data is above a first threshold; and lengthening a duration of the custom retention period for the first segment of data.

In some embodiments, setting the custom retention period comprises: detecting that a first priority score for a first segment of data of the one or more segments of data is below a first threshold; and shortening a duration of the custom retention period for the first segment of data.

In some embodiments, executing the one or more prioritization processes comprises: detecting that a first priority score for a first segment of data of the one or more segments of data is below a first threshold; compressing the first segment of data; and storing the first segment of data on an archive server.

In some embodiments, executing the one or more prioritization processes comprises: detecting that a second priority score for a second segment of data of the one or more segments of data is below a second threshold, wherein the second threshold is below the first threshold; and marking the second segment of data for deletion.

In some embodiments, the usage data comprises at least one of access frequency, access timeframes, and user behavior data.

Embodiments of the present disclosure also provide a computer program product for artificial intelligence based reduction of log data, the computer program product comprising a non-transitory computer-readable medium comprising code causing an apparatus to perform the steps of: analyzing, using an artificial intelligence engine, log data within a network environment and usage data associated with the log data; detecting, using the artificial intelligence engine, one or more usage patterns based on the log data and the usage data; identifying one or more segments of data within the log data based on detecting the one or more usage patterns; computing a priority score for each of the one or more segments of data; and executing one or more prioritization processes on each of the one or more segments of data based on the priority score for each of the one or more segments of data.

In some embodiments, executing the one or more prioritization processes comprises setting a custom retention period for each of the one or more segments of data based on the priority score for each of the one or more segments of data.

In some embodiments, setting the custom retention period comprises: detecting that a first priority score for a first segment of data of the one or more segments of data is above a first threshold; and lengthening a duration of the custom retention period for the first segment of data.

In some embodiments, setting the custom retention period comprises: detecting that a first priority score for a first segment of data of the one or more segments of data is below a first threshold; and shortening a duration of the custom retention period for the first segment of data.

In some embodiments, executing the one or more prioritization processes comprises: detecting that a first priority score for a first segment of data of the one or more segments of data is below a first threshold; compressing the first segment of data; and storing the first segment of data on an archive server.

In some embodiments, executing the one or more prioritization processes comprises: detecting that a second priority score for a second segment of data of the one or more segments of data is below a second threshold, wherein the second threshold is below the first threshold; and marking the second segment of data for deletion.

Embodiments of the present disclosure also provide a computer-implemented method for artificial intelligence based reduction of log data, the computer-implemented method comprising: analyzing, using an artificial intelligence engine, log data within a network environment and usage data associated with the log data; detecting, using the artificial intelligence engine, one or more usage patterns based on the log data and the usage data; identifying one or more segments of data within the log data based on detecting the one or more usage patterns; computing a priority score for each of the one or more segments of data; and executing one or more prioritization processes on each of the one or more segments of data based on the priority score for each of the one or more segments of data.

In some embodiments, executing the one or more prioritization processes comprises setting a custom retention period for each of the one or more segments of data based on the priority score for each of the one or more segments of data.

In some embodiments, setting the custom retention period comprises: detecting that a first priority score for a first segment of data of the one or more segments of data is above a first threshold; and lengthening a duration of the custom retention period for the first segment of data.

In some embodiments, setting the custom retention period comprises: detecting that a first priority score for a first segment of data of the one or more segments of data is below a first threshold; and shortening a duration of the custom retention period for the first segment of data.

In some embodiments, executing the one or more prioritization processes comprises: detecting that a first priority score for a first segment of data of the one or more segments of data is below a first threshold; compressing the first segment of data; and storing the first segment of data on an archive server.

In some embodiments, executing the one or more prioritization processes comprises: detecting that a second priority score for a second segment of data of the one or more segments of data is below a second threshold, wherein the second threshold is below the first threshold; and marking the second segment of data for deletion.

In some embodiments, the usage data comprises at least one of access frequency, access timeframes, and user behavior data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for artificial intelligence based reduction of log data, in accordance with an embodiment of the disclosure;

FIG. 2 illustrates an exemplary machine learning subsystem architecture, in accordance with an embodiment of the invention; and

FIG. 3 illustrates a method for artificial intelligence based reduction of log data, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on. ”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

As an entity's network environment grows in size and complexity, the volume of log data (e.g., logs from applications, web servers, devices, events, and/or the like) generated in the network environment may grow exponentially (e.g., multiple terabytes generated per day). With the increase in the volume of log data, it may become increasingly challenging for monitoring tools to ingest the large amount of data and retain the log data for the designated retention periods. Furthermore, the size of the log data may require a large allocation of scarce storage space, in spite of some of the log data being used minimally or sometimes not at all by users and/or applications within the network environment. Accordingly, there is a need for a more intelligent and efficient way to store log data in a prioritized manner within the network environment.

To address the above concerns among others, the system may provide an intelligent and dynamic way to reduce log data using artificial intelligence. In this regard, the system may analyze the log data along with usage-based metrics associated with the log data. In this regard, the usage-based metrics may include information such as usage patterns or behavior patterns by users and/or applications within the network environment. For example, such usage patterns may include queries executed for specified log data, frequency of queries or access of the log data, time-based access or query of data (e.g., on what days or during which time periods the log data is being accessed or queried), the manner in which the log data is used (e.g., presented on a user dashboard, fed into online processes, and/or the like), frequently used keywords, historic query trends, the duration of use of the log data, and/or the like. Accordingly, in some embodiments, the system may track user behavior data such as mouse clicks, keystrokes, mouse movements, hovers, data downloads, exports to various file formats, and/or the like. It should be understood that while reference is made to “log data” herein, it is within the scope of the disclosure for the system and processes to be applicable to other types of data within the network environment, such as network device data, metrics, scripts, configuration files, and/or the like.

Based on analyzing the log data and the metrics associated with the log data, the AI engine may identify one or more segments or groupings of data within the log data based on the usage patterns of the log data. In this regard, the AI engine may identify log data that may be highly used (e.g., log data that is frequently used by users or applications in the network environment) and/or log data that is “mission-critical” (e.g., data that is critically important to the entity's processes) as well as data that may be occasionally or infrequently used. The system may further identify data that may have never been used and/or be predicted by the AI engine to never be used or required by the entity's processes. In this way, the system may identify which segments of data may be highly used or critical, and which segments may be underused, unused, and/or redundant.

Upon identifying the segments, the system may compute a priority score for each of the segments of data, where the priority score indicates a level of priority for the segment of data. For instance, based on determining that a particular segment of log data is frequently used (e.g., based on the usage data) and/or critical (e.g., based on the contents of the log data), the system may assign a relatively higher priority score to the particular segment. On the other hand, if the system determines that the segment of log data is infrequently used or accessed based on the usage data, or that the log data contains data of relatively lesser importance, the system may assign a relatively lower priority score to the segment.

The priority score for each of the segments may then be processed by a decisioning engine of the AI engine. The decisioning engine may set customized retention policies (e.g., retention periods) and/or execute prioritization processes (e.g., selective ingestion of data for monitoring tools, storing segments differently based on performance needs, modifying level of data redundancy and availability, and/or the like) based on the priority scores of each of the segments. For example, upon detecting that the priority score of a segment exceeds a particular threshold (e.g., the segment is categorized as a “high priority” segment), the system may set a lengthened retention period (e.g., 5 years, 10 years, indefinite, and/or the like) for the segment and/or perform other prioritization processes, such as storing the segment on a high performance server, replicating the data to ensure high availability and fault tolerance, and/or the like.

On the other hand, if the system determines that the priority score of a segment falls below the threshold (e.g., the segment is categorized as a “lower priority” segment), the system may set a relatively shortened retention period (e.g., 1 year, 6 months, 1 month, and/or the like) and/or perform prioritization processes such as storing the segment on a low-use archive server, performing data compression on the segment, and/or the like. In some embodiments, upon determining that the priority score falls below a second threshold (e.g., a lower threshold than the first threshold), the system may determine that the data is unused or redundant. In this regard, the AI engine may generate a prediction, based on the content of the segment and the historical usage patterns associated with the segment, that the segment of data is currently not needed and will not be needed in the future. Accordingly, the system may exclude the ingesting of the segment of data into the monitoring tools and/or automatically delete the segment of data from the network environment or mark the segment of data for deletion within a set time period (e.g., 30 days). In this way, the system may intelligently and selectively prioritize certain portions of log data while trimming and/or archiving other portions.

The system as described herein provides numerous technical advantages over conventional data management systems. For instance, by selectively ingesting certain segments of log data and/or removing unnecessary data, the system may save precious computing resources such as storage space, processing power, networking bandwidth, and/or the like that would have been spent processing and storing the unnecessary data. In turn, the system may reduce processing and networking latency in processing or serving the data, thereby allowing the network environment to operate more efficiently. Furthermore, by intelligently computing a priority score for each segment, the system may apply custom rules and processes such as customized retention policies to efficiently allocate the computing resources to storing and processing frequently used and/or critical log data.

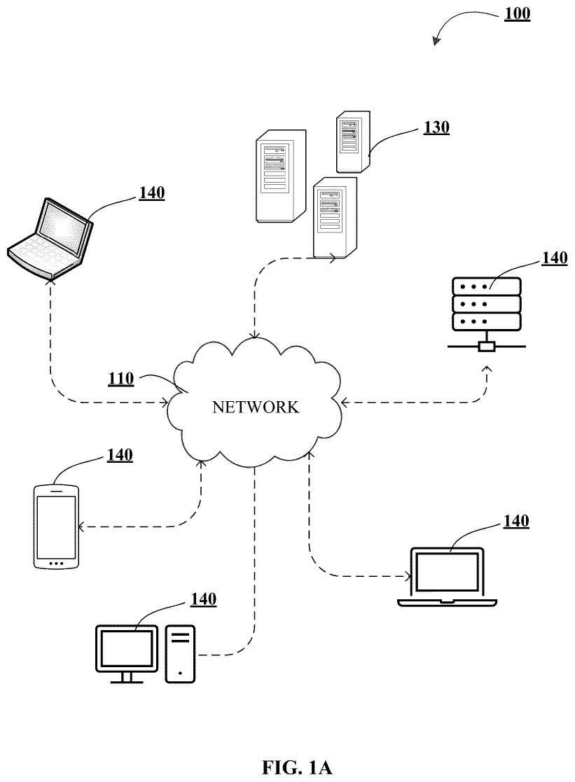

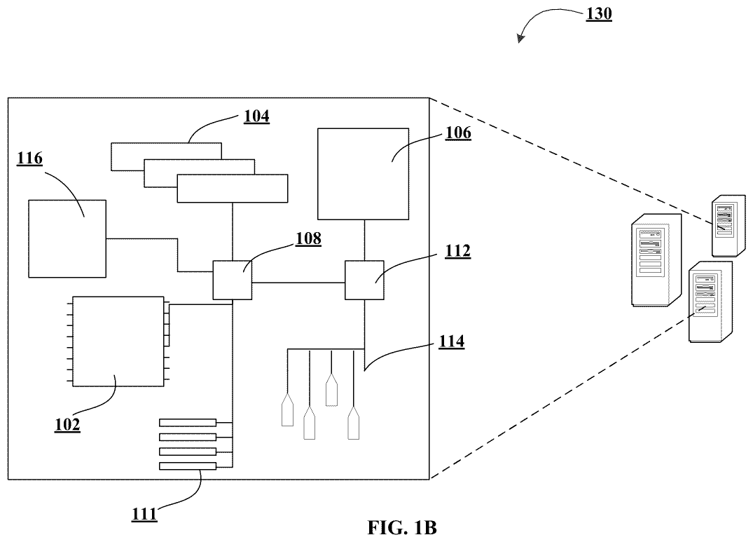

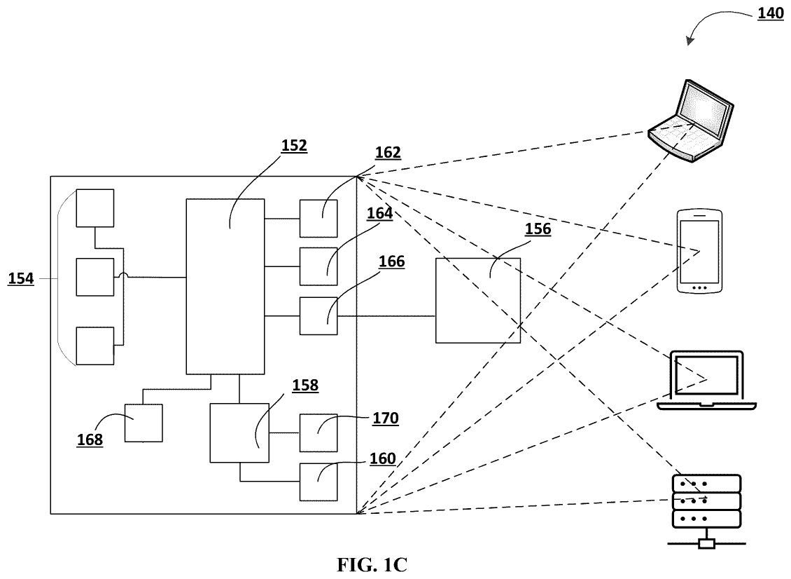

Turning now to the figures, FIGS. 1A-1C illustrate technical components of an exemplary distributed computing environment 100 for the system for artificial intelligence based reduction of log data. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

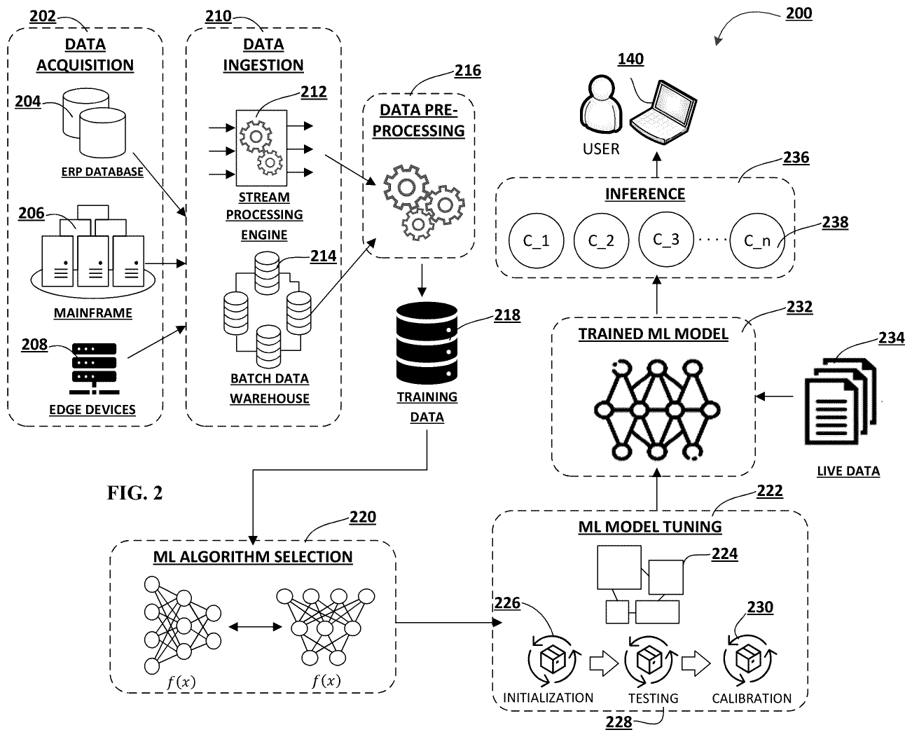

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

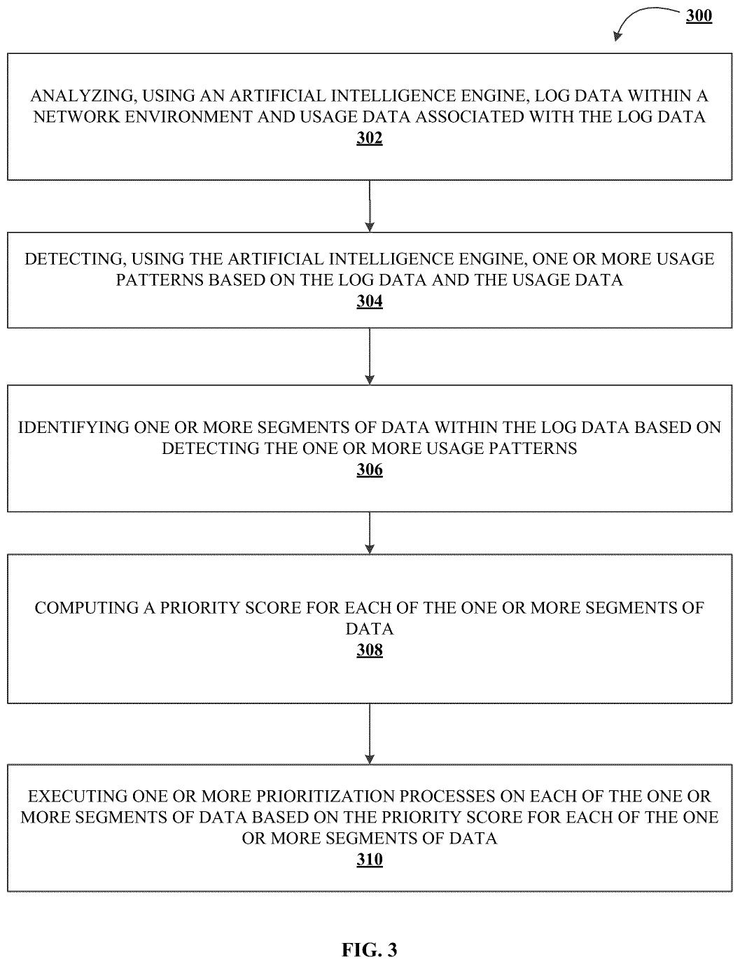

FIG. 3 illustrates a method 300 for artificial intelligence based reduction of log data. As shown in block 302, the method includes analyzing, using an artificial intelligence engine, log data within a network environment and usage data associated with the log data. The log data may comprise, for instance, logs generated by applications deployed to an entity's network environment, though it is within the scope of the disclosure for the logs to include web server logs, API logs, system event or process logs, device data, performance metric data, scripts, configuration files, and/or the like. Accordingly, the usage data may include information regarding the manner in which the log data is used, accessed, and/or viewed by users or applications within the network environment. For instance, the usage data may include the sources and/or paths accessed, the frequency and/or duration of access and use, frequent keywords used in queries, timeframes for queries and/or access, historical patterns or trends for queries, areas of focus within the log data, sections of data that have been downloaded or exported, and/or the like.

Next, as shown in block 304, the method includes detecting, using the artificial intelligence engine, one or more usage patterns based on the log data and the usage data. In this regard, the system may analyze the log data and usage data to determine which portions of the log data are frequently used and/or critical to the entity's processes and which portions of the log data may be less frequently used and/or less critical. For instance, the system may determine that a specific portion of a log data file is frequently used by detecting a pattern of user behavior that interacts with the specific portion of the log data file (e.g., areas identified by the user hovering a mouse cursor, clicking, editing, or otherwise interacting with a particular section of the log data). In other cases, the system may detect a pattern of frequent usage of a certain portion of a log file by detecting frequent keywords during searches of a log file (e.g., “error” or “exception”). In yet other embodiments, the system may detect a pattern of a particular log file or a section of the log file being viewed or edited for a lengthy duration.

Next, as shown in block 306, the method includes identifying one or more segments of data within the log data based on detecting the one or more usage patterns. In this regard, the system may divide each log file within the log data into the segments based on detecting the patterns. Accordingly, the log data may be segmented according to various levels of granularity, such as segmentation according to discrete log files, segmentations by headers or sections within log files, segmentation according to specific sets of characters, variables, or parameters, and/or the like. In this way, the system may allow the slimming process to be finely tuned to the most frequently used or important data according to the needs of the entity.

Next, as shown in block 308, the method includes computing a priority score for each of the one or more segments of data. Computing the priority score for a particular segment may comprise incrementing or decreasing the priority score based on the frequency of use of the segment by a user or application and/or a criticality of the segment for one or more processes running within the network environment. In this regard, the system may increment the priority score for highly frequently used segments and/or segments of critical importance to the entity's processes, whereas the system may decrease the priority score for lesser used segments or segments of lesser importance to the entity's processes.

Next, as shown in block 310, the method includes executing one or more prioritization processes on each of the one or more segments of data based on the priority score for each of the one or more segments of data. The one or more prioritization processes may comprise setting a custom retention period based on the priority score, where the system may lengthen the retention period based on detecting that the priority score is above a first threshold or shorten the retention period based on detecting that the priority score is below the first threshold. The system may further perform other actions based on detecting that the priority score is above a first threshold, such as increasing a redundancy of the segment of data by storing the segment on a distributed server network or storing the segment on a high performance, high traffic server. Conversely, in response to detecting that the priority score is below the first threshold, the system may perform actions such as archiving or compressing the segment and storing the segment in an archive server. In other embodiments, the prioritization processes may comprise marking one or more segments for deletion based on detecting that the priority score is below a second threshold that is below the first threshold. In this way, the system may provide a tailored solution for the ever-growing issue of log data within the network environment.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for artificial intelligence based reduction of log data, the system comprising:
a processing device;
a non-transitory storage device containing instructions when executed by the processing device, cause the processing device to perform the steps of:
analyzing, using an artificial intelligence engine, log data within a network environment and usage data associated with the log data;
detecting, using the artificial intelligence engine, one or more usage patterns based on the log data and the usage data;
identifying one or more segments of data within the log data based on detecting the one or more usage patterns;
computing a priority score for each of the one or more segments of data; and
executing one or more prioritization processes on each of the one or more segments of data based on the priority score for each of the one or more segments of data.

2. The system of claim 1, wherein executing the one or more prioritization processes comprises setting a custom retention period for each of the one or more segments of data based on the priority score for each of the one or more segments of data.

3. The system of claim 2, wherein setting the custom retention period comprises:
detecting that a first priority score for a first segment of data of the one or more segments of data is above a first threshold; and
lengthening a duration of the custom retention period for the first segment of data.

4. The system of claim 2, wherein setting the custom retention period comprises:
detecting that a first priority score for a first segment of data of the one or more segments of data is below a first threshold; and
shortening a duration of the custom retention period for the first segment of data.

5. The system of claim 1, wherein executing the one or more prioritization processes comprises:
detecting that a first priority score for a first segment of data of the one or more segments of data is below a first threshold;
compressing the first segment of data; and
storing the first segment of data on an archive server.

6. The system of claim 5, wherein executing the one or more prioritization processes comprises:
detecting that a second priority score for a second segment of data of the one or more segments of data is below a second threshold, wherein the second threshold is below the first threshold; and
marking the second segment of data for deletion.

7. The system of claim 1, wherein the usage data comprises at least one of access frequency, access timeframes, and user behavior data.

8. A computer program product for artificial intelligence based reduction of log data, the computer program product comprising a non-transitory computer-readable medium comprising code causing an apparatus to perform the steps of:
analyzing, using an artificial intelligence engine, log data within a network environment and usage data associated with the log data;
detecting, using the artificial intelligence engine, one or more usage patterns based on the log data and the usage data;
identifying one or more segments of data within the log data based on detecting the one or more usage patterns;
computing a priority score for each of the one or more segments of data; and
executing one or more prioritization processes on each of the one or more segments of data based on the priority score for each of the one or more segments of data.

9. The computer program product of claim 8, wherein executing the one or more prioritization processes comprises setting a custom retention period for each of the one or more segments of data based on the priority score for each of the one or more segments of data.

10. The computer program product of claim 9, wherein setting the custom retention period comprises:
detecting that a first priority score for a first segment of data of the one or more segments of data is above a first threshold; and
lengthening a duration of the custom retention period for the first segment of data.

11. The computer program product of claim 9, wherein setting the custom retention period comprises:
detecting that a first priority score for a first segment of data of the one or more segments of data is below a first threshold; and
shortening a duration of the custom retention period for the first segment of data.

12. The computer program product of claim 8, wherein executing the one or more prioritization processes comprises:
detecting that a first priority score for a first segment of data of the one or more segments of data is below a first threshold;
compressing the first segment of data; and
storing the first segment of data on an archive server.

13. The computer program product of claim 12, wherein executing the one or more prioritization processes comprises:
detecting that a second priority score for a second segment of data of the one or more segments of data is below a second threshold, wherein the second threshold is below the first threshold; and
marking the second segment of data for deletion.

14. A computer-implemented method for artificial intelligence based reduction of log data, the computer-implemented method comprising:
analyzing, using an artificial intelligence engine, log data within a network environment and usage data associated with the log data;
detecting, using the artificial intelligence engine, one or more usage patterns based on the log data and the usage data;
identifying one or more segments of data within the log data based on detecting the one or more usage patterns;
computing a priority score for each of the one or more segments of data; and
executing one or more prioritization processes on each of the one or more segments of data based on the priority score for each of the one or more segments of data.

15. The computer-implemented method of claim 14, wherein executing the one or more prioritization processes comprises setting a custom retention period for each of the one or more segments of data based on the priority score for each of the one or more segments of data.

16. The computer-implemented method of claim 15, wherein setting the custom retention period comprises:
detecting that a first priority score for a first segment of data of the one or more segments of data is above a first threshold; and
lengthening a duration of the custom retention period for the first segment of data.

17. The computer-implemented method of claim 15, wherein setting the custom retention period comprises:
detecting that a first priority score for a first segment of data of the one or more segments of data is below a first threshold; and
shortening a duration of the custom retention period for the first segment of data.

18. The computer-implemented method of claim 14, wherein executing the one or more prioritization processes comprises:
detecting that a first priority score for a first segment of data of the one or more segments of data is below a first threshold;
compressing the first segment of data; and
storing the first segment of data on an archive server.

19. The computer-implemented method of claim 18, wherein executing the one or more prioritization processes comprises:
detecting that a second priority score for a second segment of data of the one or more segments of data is below a second threshold, wherein the second threshold is below the first threshold; and
marking the second segment of data for deletion.

20. The computer-implemented method of claim 14, wherein the usage data comprises at least one of access frequency, access timeframes, and user behavior data.
